(19) United States
(12) Patent Application Publication
(10) Pub. No.: US 2004/0184628 A1
(43) Pub. Date: Sep. 23, 2004

(54) Speaker apparatus

(75) Inventors: Niro Nakamichi, Tokyo (JP); Takaaki Yamagisawa, Tokyo (JP)

Correspondence Address: DARBY & DARBY P.C., P. O. BOX 5257, NEW YORK, NY, 10150-5257, US

(73) Assignee: niro1.com Inc., Tokyo (JP)

(21) Appl. No.: 10/797,361

(22) Filed: Mar. 9, 2004

(30) Foreign Application Priority Data
Mar. 20, 2003 (JP) 2003-76957
Mar. 20, 2003 (JP) 2003-76958

(51) Int. Cl. H04B 15/00; H04R 5/02

(52) U.S. Cl. 381/302; 381/389

(57) ABSTRACT

The present invention comprises an L channel speaker unit which produces an L channel signal; a R channel speaker unit which produces a R channel signal; and a center speaker unit which is placed between the L channel speaker unit and the R channel speaker unit and which produces a −L channel signal and a −R channel signal. For speakers mounted in an automobile described above, the L channel speaker unit and the R channel speaker unit are placed in the front center of the driver seat and passenger seat of an automobile, and the horizontal vibration axis is in a direction pivoting in a direction from the direction of motion of the automobile, and a vertical vibration axis is at a prescribed angle incline in the direction of motion of the automobile.

### INCORPORATION BY REFERENCE

The present application claims priority under 35 U.S.C. §119 to Japanese Patent Application Nos. 2003-076957 filed on Mar. 20, 2003 and 2003-76958 filed on Mar. 20, 2003. The contents of the applications are incorporated herein by reference in their entirety.

### BACKGROUND TO THE INVENTION

The present invention relates to a speaker apparatus and in one embodiment the speaker apparatus can be installed inside an automobile.

In the prior art, a L channel speaker and a R channel speaker are placed a prescribed distance apart in front of the listener. The optimal layout for stereo reproduction is to have the lines that connect these two speakers and the listener form an equilateral triangle. However, in order to have the left and right speakers separated by a prescribed distance, a large space for installation is necessary.

U.S. Pat. No. 6,169,812 to Miller, for example, disclosed a speaker in which an L channel speaker unit, R channel speaker unit, and a center speaker unit are housed in a single box. The L channel speaker unit outputs a L−R signal, the R channel speaker outputs a R−L signal, and a center speaker, which is placed between the L channel speaker and the R channel speaker, outputs an L+R signal.

With this circuit treatment, even though the three speaker units are placed in a single speaker box, a stereo image that is greater than the distance between the L/R channel speaker units can be produced. However, because an L+R signal is outputted from the center speaker unit and a L−R signal is outputted from the L channel speaker unit, a region of (L+R)+(L−R)=2L which emphasizes the L channel signal is created between the center speaker unit and the L channel speaker unit. Because there is an unnatural stereo image in this region, this has the disadvantage of having a narrow listening area

With regard to speaker systems mounted in automobiles, in Japanese Patent Application No. 2001-274299 by the present inventors, three speakers are placed on an automobile dashboard in the center area of the dashboard. An L−R signal in which the R channel signal is subtracted from the L channel signal is outputted from the L channel speaker. A R−L signal is outputted from the R channel speaker, and a L+R signal is outputted from the center speaker. This results in a speaker system with a wide stereo image even with a narrow speaker spacing.

In addition, in Japanese Patent Application 2002-46323, by the present inventors, proposed a layout for the speaker units so that the vibration axis of the aforementioned speaker units is in the direction of the front glass.

As a result of subsequent research and development, it was determined that in order to have a wider stereo image, the angle of the vibration axes of the speaker units is important.

### SUMMARY OF THE INVENTION

In order to solve the above problems, the present invention comprises an L channel speaker unit which produces an L channel signal; a R channel speaker unit which produces a R channel signal; and a center speaker unit which is placed between the L channel speaker unit and the R channel speaker unit and which produces a −L channel signal and a −R channel signal.

In order to solve the above problem described above regarding speakers mounted in an automobile, the present invention comprises: a L channel speaker unit which is placed in the front center of the driver seat and passenger seat of an automobile, and its vibration axis in the horizontal direction is in a direction pivoting in a counterclockwise direction from the direction of motion of the automobile, and the vibration axis in the vertical direction is at a prescribed angle incline in the direction of motion of the automobile. A R channel speaker unit, placed in the front center of the driver seat and passenger seat of an automobile, and the vibration axis in the horizontal direction is pivoted in the clockwise direction from the direction of motion of the automobile, and in the vertical direction, the vibration axis is at a prescribed angle incline in the direction of motion of the automobile.

### BRIEF DESCRIPTION OF THE FIGURES

FIG. 1 is a plan view of the interior of an automobile.

FIG. 2 is a plan view of speaker units 11-13.

FIG. 3 is a cross-sectional diagram along line 3-3 of FIG. 1.

FIG. 4 is a cross-sectional diagram along line 4-4 of FIG. 1.

FIG. 5 is a circuit block diagram.

### DESCRIPTION OF THE PREFERRED EMBODIMENTS

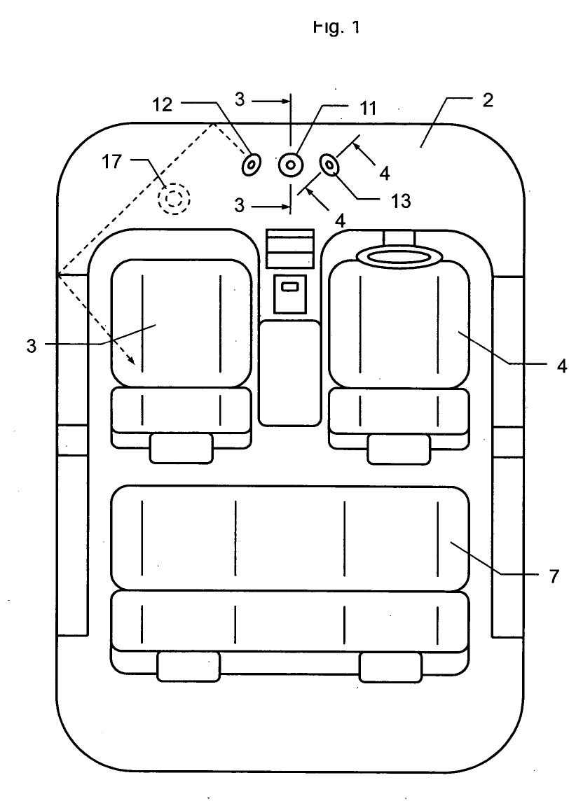

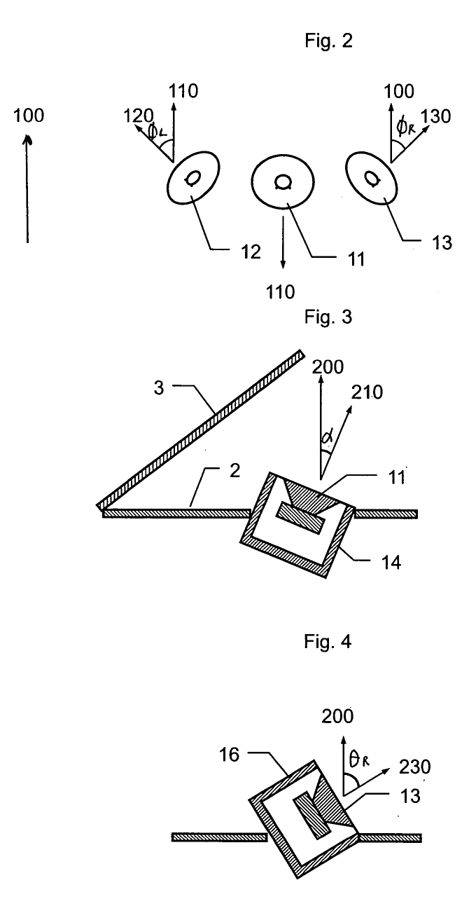

The present invention is described in detail below using the embodiment shown in the figures. Referring to FIG. 1, illustrating a plan view showing the interior of an automobile. A center speaker unit 11, L channel speaker unit 12, and R channel speaker 13 are placed on dashboard 2 in the center of the width direction of the automobile. The direction of the vibration axis of these speaker units is described using FIG. 2 which is a plan view of speaker units 11, 12, 13, FIG. 3 which is a cross-sectional drawing along line 3-3 of center speaker unit 11 in FIG. 1, and FIG. 4 which is a cross-sectional drawing along line 4-4 of R channel speaker unit 13 of FIG. 1.

The horizontal vibration axis 110 of center speaker unit 11 is parallel to the direction of motion 100 of the automobile. A vertical vibration axis 210 is at an angle α, which can be inclined at any angle, but preferrably at a 25 degree incline to vertical axis 200 to the rear of the automobile. Vertical vibration axis 210 of center speaker unit 11 is placed so that a line extending from vertical vibration axis 210 intersects with a front glass 3 of the automobile. R channel speaker unit 13 has a horizontal vibration axis 130 at an angle Φ_{R} which can be set to any angle but in one embodiment is at an angle of 48 degrees clockwise in the direction of motion of the automobile. R channel speaker 13 also has a vertical vibration axis 230 at an incline angle θ_{R}. Angle θ_{R} can be set to any angle and in one embodiment is at 65 degrees from vertical axis 200 toward the front of the automobile. L channel speaker unit 12 has a horizontal vibration axis 120 at an angle Φ_{L} Angle Φ_{L} can be set to any angle, but one embodiment is at 48 degrees counterclockwise in direction of motion of the automobile. L channel speaker has a vertical vibration axis 200 inclined at an angle θ_{L} (not shown) but similar to R channel speaker unit 13. Angle θ_{L} can be set to any angle, but one embodiment sets angle θ_{L} at an incline of 65 degrees to the front of the automobile. Speaker units 11, 12, 13 are installed in sealed enclosures 14, 15, 16, respectively. In addition, with the present embodiment, a subwoofer 17 is provided underneath the glove compartment.

The embodiment of the placement of speaker units 11, 12, 13 as described above, the sound produced from L channel speaker unit 12 is radiated at an angle Φ_{L} of approximately 48 degrees in the horizontal direction with respect to front glass 3. As a result, the sound reflected by front glass 3 is then reflected from the side glass (not shown) on the side of a passenger seat 3. Next, the sound is radiated along the arrows indicated by the dashed line in FIG. 1 towards the listener seated in passenger seat 3 or driver seat 4. Similarly, the sound produced from R channel speaker unit 13 is radiated at angle Φ_{R} of approximately 48 degrees in the horizontal direction with respect to front glass 3. As a result, the sound reflected from front glass 3 is reflected by the side glass (not shown) on the side of driver seat 4. Next, the sound is radiated towards the listener seated on passenger seat 3 or driver seat 4.

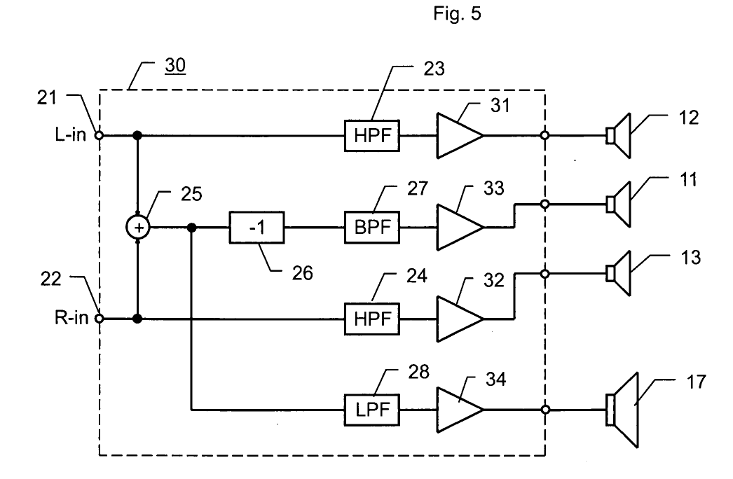

Referring to FIG. 5, there is shown a circuit block diagram for driving speaker units 11, 12, 13, 17. An L channel signal inputted from an L channel input terminal 21 passes through a high pass filter (HPF) 23 with a cutoff frequency of 170 Hz. Next, the L channel signal is amplified by an amplifier 31 and produced by L channel speaker unit 12. Similarly, an R channel signal inputted from an R channel input terminal 22 passes through a HPF 24 which has a cutoff frequency of 170 Hz. After being amplified by an amplifier 32, the R channel signal is produced by R channel speaker unit 13.

After adding the L channel signal and R channel signal by an adder 25, this summed signal is put in a reverse phase by a reverser 26. After passing the signal through a band pass filter (BPF) 27 which outputs in the region from 300 Hz to 2 KHz, this is amplified by an amplifier 33 and is produced by center speaker unit 11. Therefore, an intermediate component of an additive signal of −L signal and a −R signal (−L−R signal or ((−L)+(−R)) signal) is produced from center speaker unit 11.

By inputting the output of adder 25, prior to reverser 26, into a low pass filter 28 which has a cutoff frequency of 170 Hz, the signal approximately 150 Hz and below is amplified by an amplifier 34, and this is then inputted to subwoofer 17 (L+R). By the above circuit structure, the L channel signal from L channel speaker unit 12 reaches both ears of the listeners seated in driver seat 4 and passenger seat 3. However, the −L signal, which is produced from center speaker unit 11 and which is a reverse phase signal of the L channel signal, similarly reaches both ears of the listener. This −L signal cancels out the L channel signal in the area near the right ear more than near the left ear. Therefore, there is a difference in signal levels in the areas near the right and left ears of the listeners. As a result, the sound image of the L channel is identified as being near the front left side of the listener.

In addition, as shown by the dashed line in FIG. 1, due to the sound being reflected from front glass 3 and the side glass, the sound produced from L channel speaker unit 12 reaches the listener from the left side. As a result, the listener identifies the sound image of the L channel as being from the front left side. As a result, as shown in FIG. 1, even if speaker units 11, 12, 13 are placed close together on dashboard 2, a stereo image that is not inferior to one with a wider speaker distance is possible.

Further, the sound produced from center speaker unit 11 also radiates towards front glass 3, and the proportion of sound that is directed directly towards the listener from center speaker unit 11 is less. Therefore, particularly with vocals and the like, the monaural components produced by center speaker unit 11 reaches the listener after being reflected by front glass 3. Because of this, the sound image is positioned above the listener, and production of sound with presence is possible.

The present invention is not limited to the above embodiment and can have various modes. For example, the attachment angles, α, Φ_{L}, θ_{L}, Φ_{R}, θ_{R} for center speaker unit 11, L channel speaker unit 12, R channel speaker unit 13 in the above embodiment can be changed as needed depending on the position of dashboard 2 in the depth direction or the incline angle of the front glass, or the like.

As described above, with the present invention, a rich sound can be achieved even while installing the speaker units on a dashboard of an automobile and a speaker apparatus which can achieve a stereo image that is greater than the installation distance of the speakers.

What is claimed is:

1. A speaker apparatus for mounting in an automobile, comprising:
an L channel speaker unit placed forward of a driver seat and a passenger seat of the automobile having:
a horizontal vibration axis is in a direction pivoted counterclockwise from a forward direction of motion of said automobile, and
a vertical vibration axis is directed at an incline of a prescribed angle in the direction of motion of said automobile;
an R channel speaker unit placed forward of the driver seat and the passenger seat of the automobile having:
a horizontal vibration axis in a direction pivoted clockwise from the forward direction of motion of said automobile, and a vertical vibration axis at an incline of a prescribed angle in the direction of motion of said automobile.

2. The speaker apparatus for mounting in an automobile, as described in claim 1, comprising:
a center speaker unit disposed with said L channel speaker and R channel speaker and which outputs a −L−R signal in which a −L signal which is a reverse phase signal of said L channel signal is added to a −R signal which is a reverse phase signal of said R channel signal.

3. The speaker apparatus for mounting in an automobile, as described in claim 2, wherein:
said center speaker unit is placed so that a line extending from a vertical vibration axis thereof intersects with a front glass of said automobile.

4. The speaker apparatus for mounted in an automobile, as described in claim 2, further comprising:
a subwoofer disposed separate from said center speaker unit, said L channel speaker and said R channel speaker which outputs a L+R signal.

5. The speaker apparatus according to claim 3 wherein said center channel vertical vibration axis is inclined.

6. A speaker apparatus, comprising:
an L channel speaker unit which produces an L channel signal;
an R channel speaker unit which produces an R channel signal;
a center speaker unit, which is placed between said L channel speaker unit and said R channel speaker unit and which produces a −L channel signal and −R channel signal.

7. The speaker apparatus as described in claim 6, further comprising:
a horizontal vibration axis of said L channel speaker unit is pivoted counterclockwise from a forward direction of motion of said automobile;
a vertical vibration axis of said L channel speaker unit is directed at a prescribed angle in the direction of motion of said automobile;
a horizontal vibration axis of said R channel speaker unit is pivoted clockwise from the forward direction of motion of said automobile; and
a vertical vibration axis of said R channel speaker unit is inclined a prescribed angle in the direction of motion of said automobile;
wherein said L channel speaker unit, said R channel speaker unit, and said center speaker unit are placed forward of a driver seat and a passenger seat of an automobile.
